(19) United States
(12) Patent Application Publication
(10) Pub. No.: US 2025/0373817 A1
(43) Pub. Date: Dec. 4, 2025

(54) REFERENCE PICTURE BOUNDARY EXTENSION BY EXTRAPOLATION

(71) Applicant: Tencent America LLC, Palo Alto, CA (US)

(72) Inventors: Biao WANG, San Jose, CA (US); Madhu PERINGASSERY KRISHNAN, Mountain View, CA (US); Lien-Fei CHEN, Palo Alto, CA (US); Roman CHERNYAK, Santa Clara, CA (US); Xin ZHAO, San Jose, CA (US); Shan LIU, San Jose, CA (US)

(73) Assignee: Tencent America LLC, Palo Alto, CA (US)

(21) Appl. No.: 19/301,810

(22) Filed: Aug. 15, 2025

Related U.S. Application Data
(63) Continuation of application No. PCT/US2024/031658, filed on May 30, 2024.
(60) Provisional application No. 63/527,714, filed on Jul. 19, 2023.

(51) Int. Cl. H04N 19/159; H04N 19/117; H04N 19/172; H04N 19/593

(52) U.S. Cl. CPC H04N 19/159; H04N 19/117; H04N 19/172; H04N 19/593

(57) ABSTRACT

Methods and apparatuses for video decoding and video encoding and a method of processing visual media data are described. The apparatus for video decoding includes processing circuitry configured to determine one of a filter and an intra prediction mode based on reconstructed samples in a first region that are within a current picture. The first region includes a first template and a second template. The second template includes reconstructed samples on a boundary of the current picture and is located between the first template and the boundary of the current picture. The processing circuitry is configured to extrapolate, using the one of the filter and the intra prediction mode, values of samples in a third template that is outside the boundary of the current picture based on values of reconstructed samples in the second template.

### RELATED APPLICATION

The present application is a continuation of International Application No. PCT/US2024/031658, filed on May 30, 2024, which claims the benefit of priority to U.S. Provisional Application No. 63/527,714, “Reference Picture Boundary Handling” filed on Jul. 19, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of the visual media data according to a format rule. The bitstream includes a syntax element indicating that a second template that is at a boundary of a current picture is intra predicted, the second template being within the current picture. The format rule specifies that filter coefficients of a filter are determined based on (i) predicted samples of the second template that are obtained by applying the filter to a first template and (i) reconstructed samples in the second template. The first template and the second template are within a current picture. The second template includes reconstructed samples on the boundary of the current picture and is located between the first template and the boundary of the current picture. The format rule specifies that values of samples in a third template that are outside the boundary of the current picture are extrapolated by applying the filter with the determined filter coefficients to one of (i) the reconstructed samples in the second template and (ii) previously extrapolated samples in the third template.

In an example, the format rule specifies that a dimension of the second template along a side of the boundary is equal to a dimension of a coding block along the side of the boundary, and a dimension of the first template along the boundary is greater than the dimension of the second template along the side of the boundary.

In an aspect, a method for video encoding includes determining filter coefficients of a filter based on (i) predicted samples of a second template that are obtained by applying the filter to a first template and (i) reconstructed samples in the second template. The first template and the second template are within a current picture. The second template includes reconstructed samples on a boundary of the current picture and is located between the first template and the boundary of the current picture. The method for video encoding includes extrapolating values of samples in a third template that are outside the boundary of the current picture by applying the filter with the determined filter coefficients to one of (i) the reconstructed samples in the second template and (ii) previously extrapolated samples in the third template.

In an example, a dimension of the second template along a side of the boundary is equal to a dimension of a coding block along the side of the boundary, and a dimension of the first template along the boundary is greater than the dimension of the second template along the side of the boundary.

In an example, a dimension of the first template along a side of the boundary includes a sum of (i) a dimension of a coding block along the side of the boundary and (ii) a parameter that depends on a minimum of a width of the coding block and a height of the coding block.

In an example, the second template is predicted using extrapolation-based intra prediction.

According to an aspect of the disclosure, an apparatus for video decoding includes processing circuitry. The processing circuitry is configured to determine one of a filter and an intra prediction mode based on reconstructed samples in a first region that are within a current picture. The first region includes a first template and a second template. The second template includes reconstructed samples on a boundary of the current picture and is located between the first template and the boundary of the current picture. The processing circuitry is configured to extrapolate, using the one of the filter and the intra prediction mode, values of samples in a third template that is outside the boundary of the current picture based on values of reconstructed samples in the second template.

In an aspect, the one of the filter and the intra prediction mode is the filter. The processing circuitry is configured to determine filter coefficients of the filter based on (i) predicted samples obtained by applying the filter to the first template and (i) the reconstructed samples in the second template. The processing circuitry is configured to extrapolate the values of the samples in the third template by applying the filter with the determined filter coefficients to one of (i) the reconstructed samples in the second template and (ii) previously extrapolated samples in the third template.

In an example, a dimension of the second template along a side of the boundary is a dimension of a coding block along the side of the boundary, and a dimension of the first template along the boundary is greater than the dimension of the second template along the side of the boundary.

In an example, a dimension of the first template along a side of the boundary includes a sum of (i) a dimension of a coding block along the side of the boundary and (ii) a parameter that depends on a minimum of a width of the coding block and a height of the coding block.

In an example, a position of the first template relative to the second template depends on a position of the second template relative to the boundary of the current picture.

In an example, three filter shapes include a first filter shape F0 with a number of input samples in a vertical direction that is equal to a number of the input samples in a horizontal direction, a second filter shape F1 with a number of input samples in the horizontal direction that is greater than a number of the input samples in the vertical direction, and a third filter shape F2 with a number of input samples in the vertical direction that is greater than a number of the input samples in the horizontal direction. The processing circuitry is further configured to receive coded information including a syntax element indicating a filter shape of the filter as one of the three filter shapes and determine the filter shape of the filter based on the syntax element.

In an example, the processing circuitry is configured to determine whether to extrapolate the values of the samples in the third template based on whether the second template is reconstructed using intra prediction. When the second template is reconstructed using intra prediction, the processing circuitry is configured to perform the extrapolation of the values of the samples in the third template.

In an example, the one of the filter and the intra prediction mode is the intra prediction mode. The processing circuitry is configured to determine the intra prediction mode used to extrapolate as the intra prediction mode used to obtain the reconstructed samples in the first region and extrapolate the values of the samples in the third template from the reconstructed samples in the second template using the intra prediction mode.

In an example, the processing circuitry is configured to extrapolate the values of the samples in the third template using the filter when the second template is predicted using extrapolation-based intra prediction and extrapolate the values of the samples in the third template using the intra prediction mode when the second template is predicted using the intra prediction mode.

Aspects of the disclosure also provide an apparatus for video encoding. The apparatus for video encoding includes processing circuitry configured to implement any of the described methods for video encoding.

Aspects of the disclosure also provide a method for video decoding. The method includes any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4A shows an example of intra mode coding with 67 intra prediction modes according to an aspect of the disclosure.

FIG. 4B shows intra prediction modes according to an aspect of the disclosure.

FIG. 4C shows an example of 4 reference lines 0-3 adjacent to a current block according to an aspect of the disclosure.

FIG. 5 shows examples of three types of reconstructed areas according to an aspect of the disclosure.

FIG. 6 shows examples of three types of filter shapes according to an aspect of the disclosure.

FIGS. 7A-7C show an example of predicting samples in a current block based on an extrapolation filter-based intra prediction (EIP) mode according to an aspect of the disclosure.

FIG. 8 shows an example of a motion vector (MV) pointing out of a picture boundary of a reference picture according to an aspect of the disclosure.

FIG. 9A shows an example of a repetitive boundary padding according to an aspect of the disclosure.

FIG. 9B shows an example of motion compensation boundary padding according to an aspect of the disclosure.

FIG. 10 shows an example illustrating motion compensation (MC) boundary padding according to an aspect of the disclosure.

FIGS. 11A-11C show examples of extrapolating samples of a boundary of a current picture according to an aspect of the disclosure.

FIG. 12 shows an example where a size of a first template is based on a size of a coding block according to an aspect of the disclosure.

FIG. 13 shows an example of extrapolating samples recursively in a third template with a filter in a diagonal scan order according to an aspect of the disclosure.

FIG. 14 shows an example of padding samples for a filter input when extrapolating samples that are out of a picture boundary according to an aspect of the disclosure.

FIG. 15 shows an example of an extrapolation method performed with an angular intra prediction mode according to an aspect of the disclosure.

FIG. 16 shows a flow chart outlining a decoding process according to some aspects of the disclosure.

FIG. 17 shows a flow chart outlining an encoding process according to some aspects of the disclosure.

FIG. 18 is a schematic illustration of a computer system in accordance with an aspect.

### DETAILED DESCRIPTION

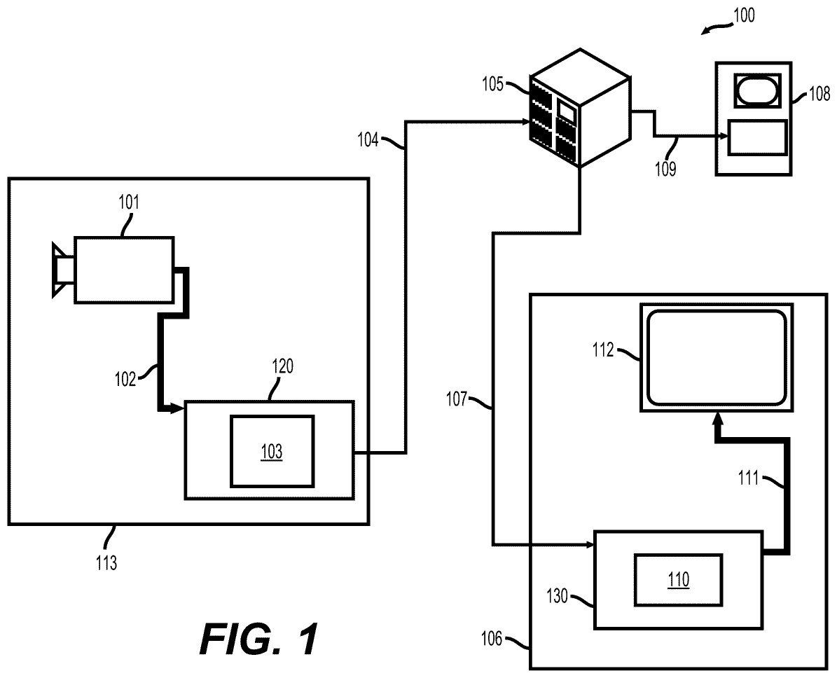

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

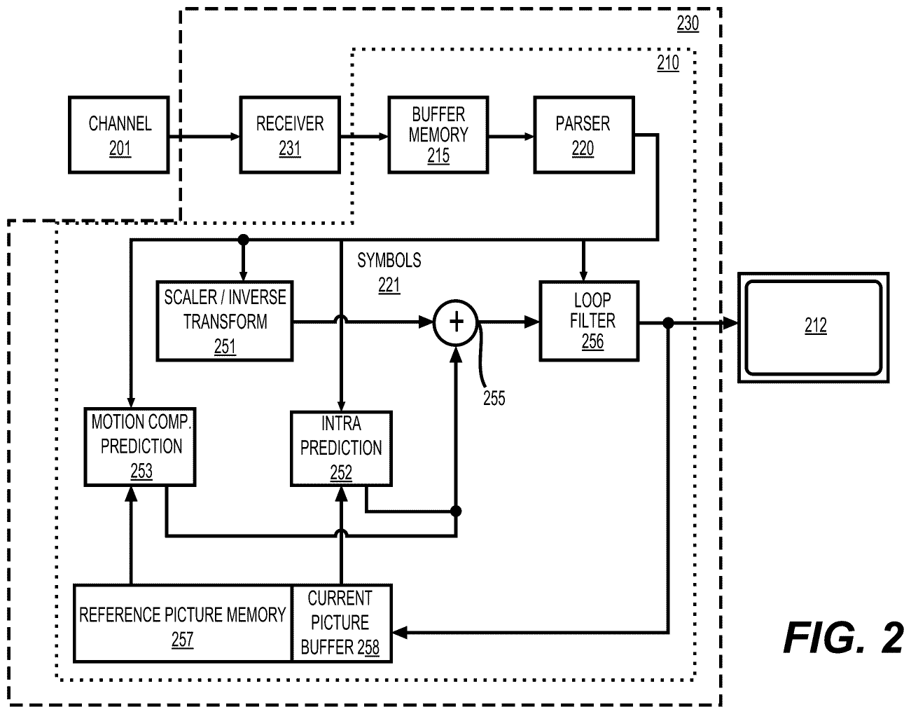

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

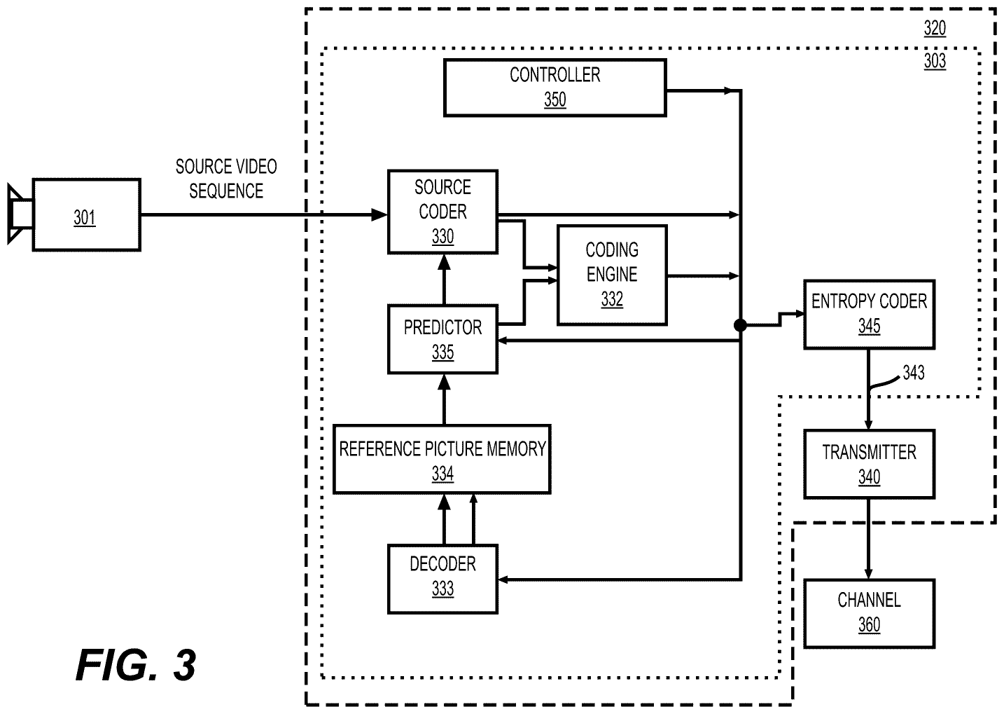

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Intra prediction may be used in video and/or image coding. Intra prediction techniques may include the DC and planar modes, angular prediction modes, matrix-based prediction modes for a luma component, cross-component prediction modes for a chroma component, and the like. Additional intra coding tools such as used in VVC as compared to HEVC may include: 67 intra modes with wide angles mode extension; block size and mode dependent 4 tap interpolation filter; position dependent intra prediction combination (PDPC); cross component linear model (CCLM) intra prediction; multi-reference line (MRL) intra prediction; intra sub-partitions (ISP); weighted intra prediction with matrix multiplication; and the like.

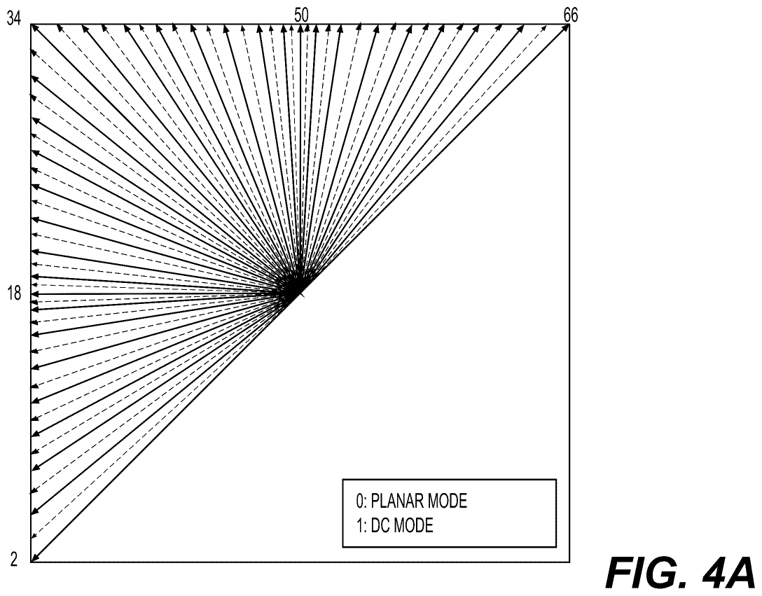

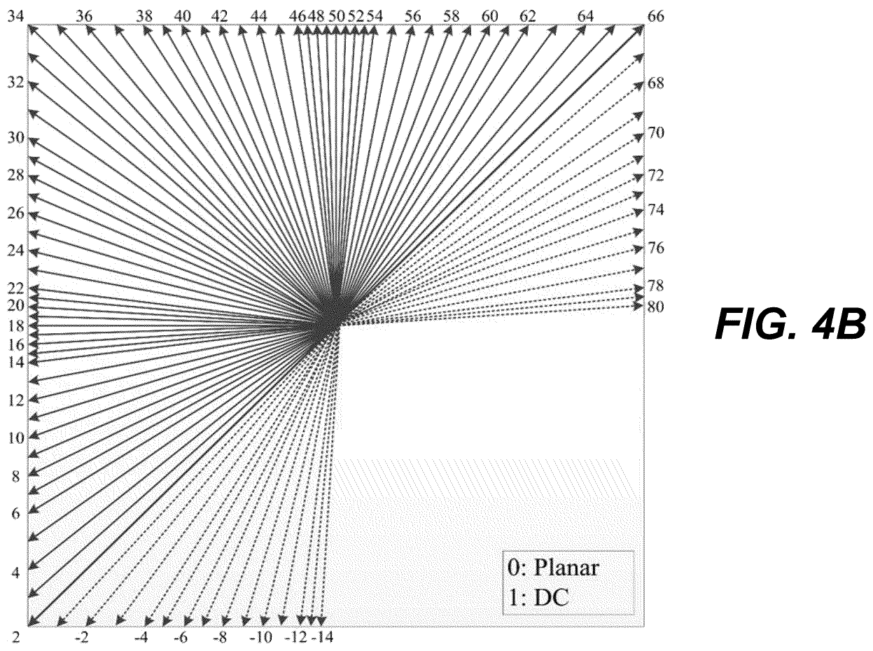

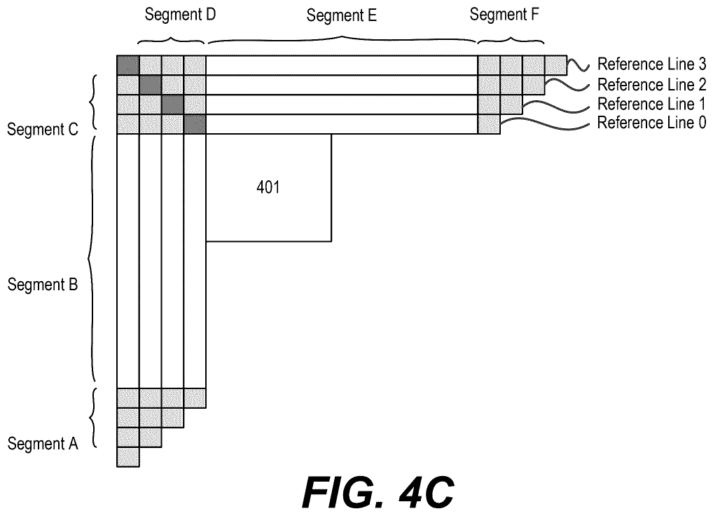

In an example, intra mode coding with 67 intra prediction modes is illustrated in FIG. 4A. To capture the arbitrary edge directions presented in a natural video, the number of directional intra modes (also referred to as angular intra prediction modes) such as used in VVC is extended from 33, as used in HEVC for example, to 65. The new directional modes that are not in HEVC are depicted as dotted arrows in FIG. 4A, and the planar and DC modes remain the same. The denser directional intra prediction modes may apply to various block sizes (e.g., all block sizes) and to both luma and chroma intra predictions. In an example, such as in VVC, certain angular intra prediction modes are adaptively replaced with wide-angle intra prediction modes for the non-square blocks.

In an example, such as in HEVC, an intra-coded block (e.g., every intra-coded block) has a square shape and the length of each side may be a power of 2. Thus, no division operations are required to generate an intra-predictor using the DC mode. In an example, such as in VVC, blocks can have a rectangular shape. In some examples, a division operation per block may be used (e.g., may be required). To avoid division operations for the DC prediction, in some examples, only the longer side is used to compute the average for non-square blocks.

An example of intra mode coding is described as follows. To keep the complexity of the most probable mode (MPM) list generation low, an intra mode coding method with 6 MPMs may be used by considering two available neighboring intra modes. The following three aspects may be considered to construct the MPM list: default intra modes, neighboring intra modes, and derived intra modes. In an example, a unified 6-MPM list is used for intra blocks irrespective of whether MRL and ISP coding tools are applied or not. The MPM list may be constructed based on intra modes of the left and above neighboring blocks of the current block.

In an example, a 4-tap interpolation filter and reference sample smoothing may be applied. Four-tap intra interpolation filters (IF) may be utilized to improve the directional intra prediction accuracy. A two-tap linear interpolation filter, such as in HEVC, may be used to generate the intra prediction block in the directional prediction modes (e.g., excluding Planar and DC predictors). In some examples, such as in VVC, two sets of 4-tap IFs may replace lower precision linear interpolation such as in HEVC, where one set is a DCT-based interpolation filter (DCTIF) and the other set is a 4-tap smoothing interpolation filter (SIF). The DCTIF may be constructed in the same way as the one used for chroma component motion compensation in both HEVC and VVC. The SIF may be obtained by convolving the 2-tap linear interpolation filter with a [1 2 1]/4 filter.

Depending on the intra prediction mode, the following reference samples processing may be performed in some examples:
The directional intra-prediction mode is classified into one of the following groups:
   Group A: vertical or horizontal modes (HOR_IDX, VER_IDX),
   Group B: directional modes that represent non-fractional angles (−14, −12, −10, −6, 2, 34, 66, 72, 76, 78, 80) and Planar mode,
   Group C: remaining directional modes;
If the directional intra-prediction mode is classified as belonging to the group A, then no filters are applied to reference samples to generate predicted samples;
Otherwise, if a mode falls into the group B and the mode is a directional mode, and all of the following conditions are true, then a [1, 2, 1] reference sample filter may be applied (depending on the mode dependent intra smoothing (MDIS) condition) to reference samples to further copy the filtered values into an intra predictor according to the selected direction, but no interpolation filters are applied:
   refIdx is equal to 0 (no MRL)
   TU size is greater than 32
   Luma
   No ISP block
Otherwise, if a mode is classified as belonging to the group C, an MRL index is equal to 0, and the current block is not an ISP block, then only an intra reference sample interpolation filter is applied to reference samples to generate a predicted sample that falls into a fractional or integer position between reference samples according to a selected direction (no reference sample filtering is performed). The interpolation filter type is determined as follows:
   Set minDistVerHor equal to Min (Abs (predModeIntra-50), Abs (predModeIntra-18))
   Set nTbS equal to (Log 2 (W)+Log 2 (H))>>1
   Set intraHorVerDistThres[nTbS] as specified below:

| | nTbS = 2 | nTbS = 3 | nTbS = 4 | nTbS = 5 | nTbS = 6 | nTbS = 7 |
|---|---|---|---|---|---|---|
| intraHorVerDistThres | 24 | 14 | 2 | 0 | 0 | 0 |
| [nTbS] | | | | | | |

If minDistVerHor is greater than intraHorVerDistThres[nTbS], SIF is used for the interpolation
Otherwise, DCTIF is used for the interpolation.

FIG. 4B shows intra prediction modes, such as intra prediction modes defined in VVC, according to an aspect of the disclosure. Referring to FIG. 4B, there are 95 intra prediction modes (e.g., a total of 95 intra prediction modes). In an example, the 95 intra prediction modes are indicated by modes −14 to 80. For example, the mode 18 is a horizontal mode, the mode 50 is a vertical mode, and the mode 2, the mode 34, and the mode 66 are diagonal modes. Modes −14 to −1 and 2 to 80 can be referred to as angular intra prediction modes. In an example, the modes −14 to −1 and 67 to 80 can be referred to as Wide-Angle Intra Prediction (WAIP) modes.

Multi-line intra prediction can be applied to video coding. In multi-line intra prediction, more reference lines (e.g., more than a reference line that is adjacent to a current block to be coded) can be used for intra prediction. An encoder can decide and signal which reference line is used to generate an intra predictor. A reference line index can be signaled before intra prediction modes. In an example, only the most probable modes are allowed in case a nonzero reference line index is signaled. FIG. 4C shows an example of 4 reference lines 0-3 adjacent to a current block (401) according to an aspect of the disclosure. In an aspect, each reference line includes six segments, i.e., Segments A to F, together with a top-left reference sample. In an example, Segments A and F are padded with the closest samples from Segments B and E, respectively.

An extrapolation filter-based intra prediction (EIP) mode may be used. In an example, an equal probability (EP) bin is used to encode the EIP mode. In an example, the EIP mode includes two steps. In a first step, the extrapolation filter coefficients may be obtained from the neighboring reconstructed pixels (or samples) of the current block with a pre-determined template. In a second step, the extrapolation may generate a predicted value position by position, for example, from a top-left sample to a bottom-right sample within the current block.

In an example, a mean value, a min value, and a max value may be searched as follows. Similar to the CCCM mode, in the EIP mode, a mean value may be removed when feeding the inputs to the EIP filter. The value of the DC mode for the current block may be used as the mean value for EIP prediction. The min value and the max value may be searched from reconstructed pixels in the reconstructed area with, for example, thirteen columns and thirteen rows.

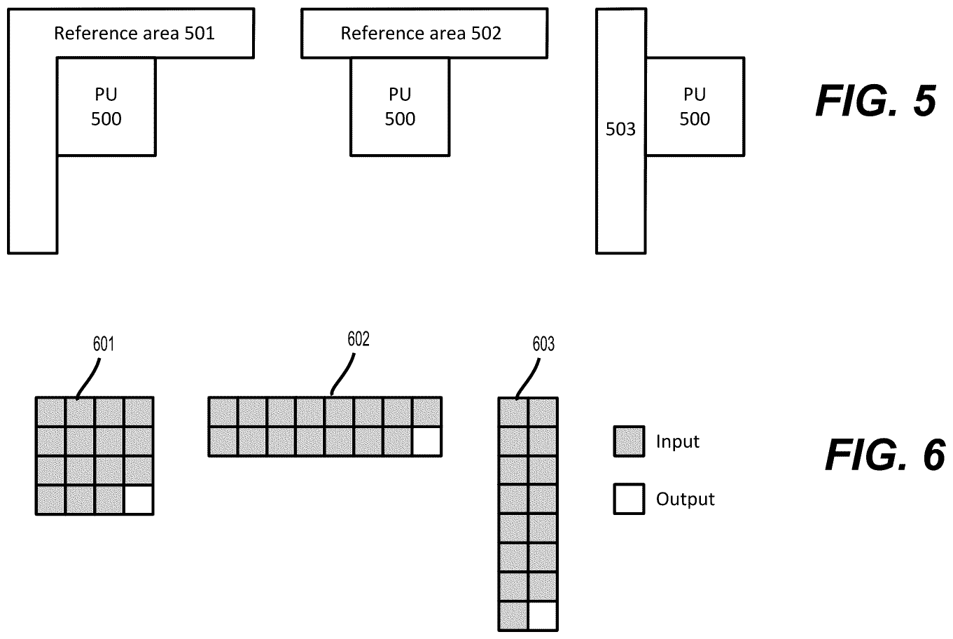

Filter coefficients may be calculated as below. FIG. 5 shows examples of the defined three types of reconstructed areas according to an aspect of the disclosure. The three types of reconstructed areas or the reference areas (501)-(503) may include thirteen columns or rows of reconstructed pixels. FIG. 6 shows examples of the defined three types of filter shapes according to an aspect of the disclosure. The three types of filter shapes (601)-(603) may include fifteen inputs (also referred to as input samples) and generate one output. When the current block uses the EIP mode for prediction, the decoder may decode the relevant syntax elements to determine the selected type of reconstructed area and filter shape for the current block.

The selected filter may slide in the selected reconstructed area with a one-pixel step to collect input samples and output samples of the EIP mode. The auto-correlation matrix and cross-correlation vector may be constructed while removing the mean value from input samples and output samples. Then, the EIP coefficients may be obtained by the same method in CCCM.

The three types of filter shapes (601)-(603) shown in FIG. 6 may be used in the EIP mode or in other applications.

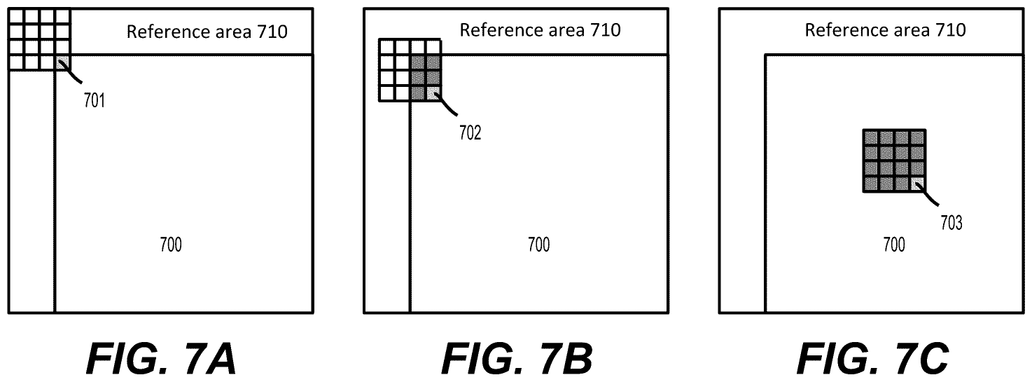

FIGS. 7A-7C show an example of predicting samples in a current block (700) based on the EIP mode according to an aspect of the disclosure. The EIP mode may predict samples in the current block position by position.

Referring to FIG. 7A, all inputs to EIP are reconstructed samples. For the position (e.g., a top-left position) (701) located at the top-left of the current block, the inputs to the EIP filter are reconstructed samples, for example, the reconstructed reference samples in the reference area (710). Referring to FIG. 7B, for the positions located along the boundaries of the current block (700), partial inputs to the EIP filter are reference samples that are already reconstructed in the reference area (710), and partial inputs to the EIP filter are previously predicted samples in the current block (700). Referring to FIG. 7C, all inputs to the EIP filter are predicted samples in the current block (700), for example, for other positions in the current block (700), the inputs to the EIP filter may include previously predicted samples in the current block (700).

To reduce the prediction error, the searched min and max values may be applied to restrict the output range of each predicted value as described in Eq. 1.

$$p r e {d}_{( x , y )} = clip ( min , max , ( ( {\sum }_{i = 0}^{n} ( {α}_{i} \times p ( {x}_{i} , {y}_{i} ) - mean ) ) + mean ) \qquad Eq . l$$

pred_{(x,y)} is the predicted value at (x, y) in the current block (700), min, max are searched min and max values from, for example, the reference area (710) (e.g., the thirteen reconstructed columns and rows), αᵢ represent the i^{th} coefficient of the derived EIP filter, p(xᵢ, yᵢ) is reconstructed or a predicted value used to predict the current position or the current sample, and mean is a mean value calculated by the DC prediction mode.

Inter prediction may be used to exploit the temporal redundancy in sequences. Within a set of consecutive frames (or pictures) in a temporal dimension, an object may move from one picture to another picture. Hence, instead of coding the object itself, the object may be derived by a prediction based on the most similar object from other decoded frames. Information to be coded may include the motion of the moving object. The terms “frame” and “picture” are used interchangeably in the disclosure.

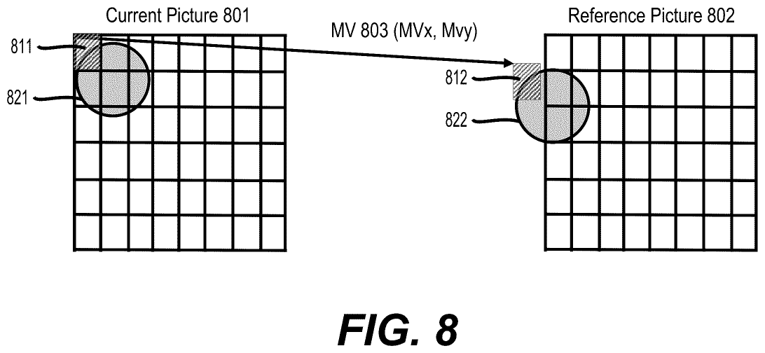

In some examples of block-based video codec, the motion information may be represented by a motion vector (MV) and a reference picture index. The MV may indicate a position of a reference block within a picture (e.g., a reference picture) and the reference picture index may indicate which decoded frame is to be referenced. In an example, the MV points out of a picture boundary as shown in FIG. 8. FIG. 8 shows an example of an MV pointing out of a picture boundary of a reference picture (802) according to an aspect of the disclosure. In FIG. 8, the reference picture (802) is already reconstructed (or decoded). A current block (811) in a current picture (801) is to be reconstructed. An MV (803) of the current block (811) points to a block (812) that is outside a boundary of the reference picture (802). Patterns (821)-(822) indicate a movement of an object between the reference picture (802) and the current picture (801).

Aspects of the disclosure provide techniques, apparatuses, and methods related to picture boundary handling such as reference picture boundary handling. For example, intra mode coding and intra prediction, for example, an intra prediction mode and/or a filter may be applied to extend a picture boundary.

Various techniques for picture boundary padding can be used. The padded portion outside the picture boundary may be used to predict other pictures. When a reference block is located partially or completely out of the picture boundary, the padded pixels in the extended area can be used similarly as pixels in the reference picture for motion compensation.

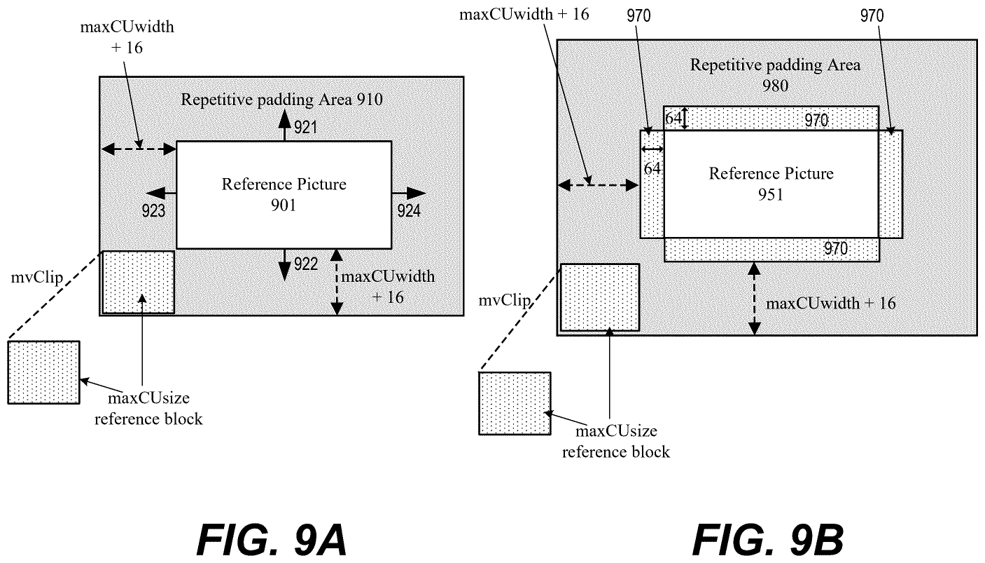

When a reference picture is an intra frame (also referred to as an intra picture or an I picture), an area outside the boundary of the reference picture may be padded repetitively by samples on the reference picture boundary, for example. The repetitive padding process may be performed on four sides of the reference picture, and the samples of the boundary may be padded upward, downward, to the left, and to the right of the boundary, such as indicated by arrows (921)-(924), respectively, in FIG. 9A.

FIG. 9A shows an example of a reference picture (901) with a padded area (e.g., a repetitive padding area) (910) that is padded according to repetitive boundary padding in some examples (e.g., ECM-4.0). In an example, in a first round of the repetitive boundary padding, first pixels in the extended area that are immediate neighbors of pixels within a picture boundary of the reference picture (901) are padded based on the pixels within the picture boundary of the reference picture (901); in a second round of the repetitive boundary padding, second pixels in the extended area that are immediate neighbors of the first pixels are padded based on the first pixels; and the repetitive boundary padding can continue until all pixels in the extended area are padded.

In a related example, a technique for motion compensation boundary padding can be used. For example, samples outside of the picture boundary are derived by motion compensation instead of using only repetitive padding. FIG. 9B shows an example illustrating a reference picture with an extended area (or a padded area) that is padded according to motion compensation boundary padding and the repetitive boundary padding. In the FIG. 9B example, a total padded area size can be increased by a pre-defined value L (e.g., 64) as compared to the padded area (910) in FIG. 9A. The extended area in FIG. 9B can include a first portion (970) that can be padded according to the motion compensation boundary padding. The first portion (970) can also be referred to as a motion compensation (MC) padding area (or an MCP area). The extended area in FIG. 9B can include a repetitive padding area (980) that is padded by repetitive padding, for example, based on the MCP area such as described in FIG. 9A.

Referring to FIGS. 9A-9B, when motion compensation with an MV pointing to a block outside a frame boundary (or a picture boundary) of a reference picture (e.g., (901) or (951)), padded pixels in the repetitive padding area (910) or in the extended area (e.g., including the repetitive padding area (980) and the MCP area (980)) in FIG. 9B can be used as reference pixels.

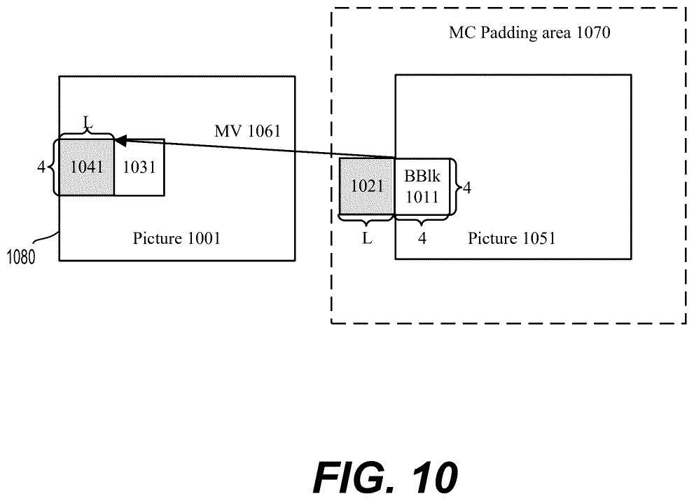

FIG. 10 shows an example illustrating motion compensation (MC) boundary padding. In the MC boundary padding, a MV (1061) can be derived based on a boundary block (BBlk) (e.g., a 4×4 boundary block) (1011) in a picture (1051). For example, the MV (1061) is determined based on motion information of the boundary block (1011). If the boundary block (1011) is intra coded, the motion information of the boundary block (1011) is not available, and a zero MV can be used. For example, the MV (1061) is set to be the zero MV.

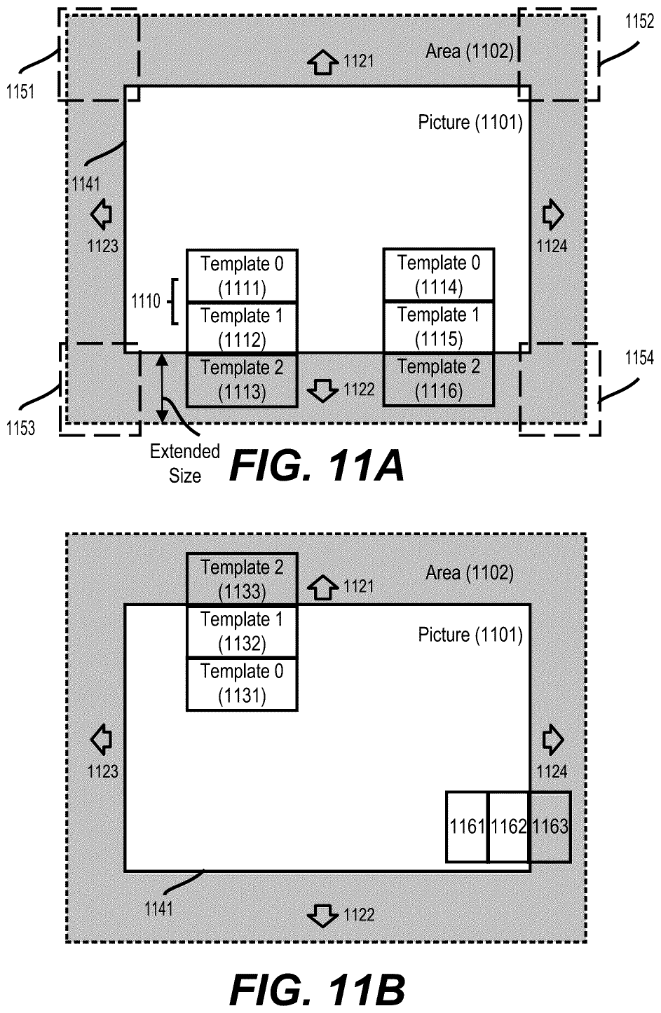

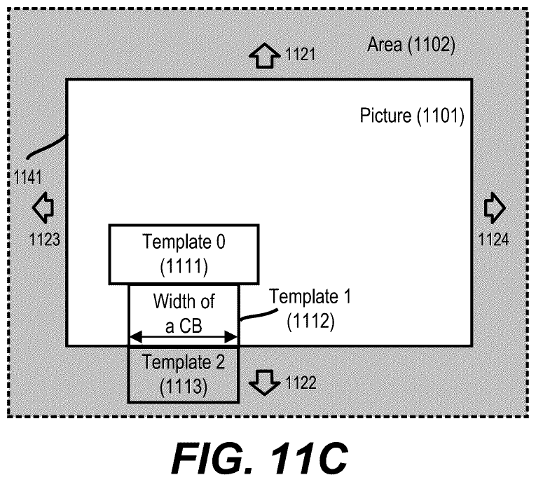

In another example, if the boundary block (1011) is intra coded, an extrapolation method based on intra prediction may be applied to extend the boundary at the boundary block (1011), such as described in FIGS. 11A-11C and 12-17 below.

If the boundary block (1011) is coded with bi-directional inter prediction, the motion information of the boundary block (1011) can include two MVs, such as a first MV pointing to a first pixel position in a first reference picture and a second MV pointing to a second pixel position in a second reference picture. In an example, only one MV (e.g., the first MV or the second MV) is used in the MC boundary padding. The MV being used in the MC boundary padding can point to a pixel position farther away from a picture boundary in a reference picture of the picture (1051). For example, if the first pixel position is farther away from a first picture boundary in the first reference picture of the picture (1051) than the second pixel position being away from a second picture boundary in the second reference picture of the picture (1051), the first MV is used (e.g., the MV (1061) is the first MV). Otherwise, the second MV can be used (e.g., the MV (1061) is the second MV).

The MV (1061) can be utilized to derive a padding block (or an MCP block) (e.g., an L×4 or 4×L padding block) (1021) in an MC padding area (1070) of the picture (1051). For example, the MV (1061) points to a reference block (also referred to as a reference boundary block or Ref BBlk) (1031) in a reference picture (1001) of the picture (1051). An MCP reference block (1041) in the reference picture (1001) that is adjacent to the reference block (1031) can be used to determine the MCP block (1021). A size of the MCP reference block (1041) can be equal to a size of the MCP block (1021). In an example, a size of the reference block (1031) is equal to a size of the boundary block (1011).

In some examples, pixels in an MC padding block (e.g., the MCP block (1021)) are modified (e.g., corrected) with an offset (e.g., a DC offset or a DC offset value). The offset can be determined based on samples in the reconstructed boundary block (e.g., the boundary block (1011) in FIG. 10) in the picture (1051) and reference samples in a corresponding reference block (e.g., the Ref BBlk (1031) in FIG. 10) in the reference picture (1001). The offset can be equal to a difference between DC values (e.g., average pixel values) of the reconstructed boundary block (e.g., the boundary block (1011)) in the picture (1051) and the corresponding reference block (e.g., the Ref BBlk (1031)) in the reference picture (1001).

The MC boundary padding method described in FIG. 10 can be combined with the repetitive padding method to determine an extended area of the picture (1051), such as described in FIG. 9B to determine the extended area of the reference picture (951). The value L can indicate a desired frame boundary extension (or the desired picture boundary extension).

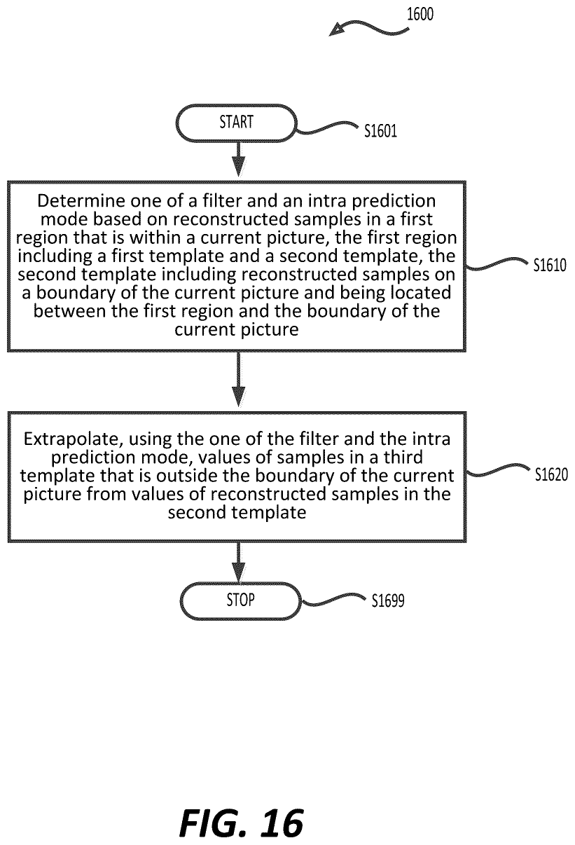

In an example, two different padded area sizes, such as 64 (shown in FIG. 9B) and 16, are implemented. L can be set at least equal to 4 if the MV (1061) points to a position internal to the reference picture bounds. In an example, if L is less than 64, the remaining portion of the MC padding area (1070) can be filled with the repetitive padded samples by using repetitive padding such as described in FIG. 9A.

In an example, the repetitive padding such as shown in FIG. 9A may be used to extend a boundary of an I picture. In an example, the MC padding such as shown in FIG. 9B may be used to extend a boundary of a P picture or a B picture.

In various examples, padding samples repetitively (e.g., the repetitive padding shown in FIG. 9A) may provide inaccurate reference samples for inter prediction when an MV points out of a boundary of a reference picture.

According to an aspect of the disclosure, an extrapolation method may be used to extend a boundary of a picture (e.g., a current picture that is under reconstruction) by extrapolating samples of an area that is outside the boundary of the picture from samples on the boundary and/or samples within the boundary with intra prediction. In the extrapolation method, the extrapolated samples in the area that is outside the boundary may provide more relevant information with the samples inside the picture, and thus improve the coding efficiency. The picture with the extended boundary may be used as a reference picture of a block in another picture that is under reconstruction.

According to an aspect of the disclosure, the extrapolation method may be performed using a filter and/or an intra prediction mode. In an aspect, one of the filter and the intra prediction mode may be determined based on reconstructed samples in a first region that is within a current picture. The first region may include a first template and a second template. The second template may include reconstructed samples on a boundary of the current picture. In an example, the second template may be located between the first template and the boundary of the current picture. Values of samples in a third template that are outside the boundary of the current picture may be extrapolated, using the one of the filter and the intra prediction mode, from values of reconstructed samples in the second template.

In an aspect, the one of the filter and the intra prediction mode that is used to perform the extrapolation method is the filter. Filter coefficients of the filter may be determined based on (i) predicted samples of the second template that are obtained by applying the filter to the first template and (i) the reconstructed samples in the second template. The values of the samples in the third template may be extrapolated by applying the filter with the determined filter coefficients to one of (i) the reconstructed samples in the second template and (ii) previously extrapolated samples in the third template, such as shown in FIGS. 11A-11B.

FIG. 11A shows an example of extrapolating samples of a bottom side (or a bottom boundary) of a boundary (1141) of a picture (1101) according to an aspect of the disclosure. In an aspect, a first region (1110) including a first template (e.g., a template 0 in FIG. 11A) (1111) and a second template (e.g., a template 1 in FIG. 11A) (1112) is already reconstructed. A filter (e.g., a pre-defined filter) may be applied to the first template (1111) to predict samples in the second template (1112). Filter coefficients of the filter may be determined (e.g., calculated) based on (i) the predicted samples in the second template (1112) (e.g., obtained by applying the filter to the first template (1111)) and (i) the reconstructed samples in the second template (1112). In an example, the filter coefficients of the filter are calculated by minimizing a cost such as, but not limited to, using a mean square error (MSE) between the predicted samples and the reconstructed samples in the second template (1112). When building the filter, samples in both the first template (1111) and the second template (1112) are within the picture boundary (1141) and are inside the picture (1101).

In an example, the values of the samples in the third template (e.g., a template 2 in FIG. 11A) (1113) may be extrapolated by applying the filter with the determined filter coefficients. The filter may be applied to one of (i) the reconstructed samples in the second template (1112) and (ii) previously extrapolated samples in the third template (1113). Referring to FIG. 11A, when the filter coefficients are available (e.g., obtained using the samples within the boundary (1141)), the filter that is already built may be applied to the samples (e.g., the reconstructed samples) in the second template (1112) to extrapolate the samples in the third template (1113), which are out of the picture boundary (1141).

In an example, the bottom side of the boundary (1141) has a dimension that is larger than a dimension (e.g., a width) of the template (1112) along the bottom side, and thus multiple sets of templates may be used to extrapolate samples in an area that is below the bottom side of the boundary (1141). Referring to FIG. 11A, a first set of templates includes the templates (1111)-(1113), and the samples in the third template (1113) may be extrapolated. A second set of templates includes templates (1114)-(1116), and the samples in the template (1116) may be extrapolated similarly as described above. Shapes of the templates (1111) and (1114) may be identical or different. Sizes of the templates (1111) and (1114) may be identical or different. Shapes of the templates (1112) and (1115) may be identical or different. Sizes of the templates (1112) and (1115) may be identical or different. Shapes of the templates (1113) and (1116) may be identical or different. Sizes of the templates (1113) and (1116) may be identical or different. Within the same set of templates such as the templates (1111)-(1113), the shapes of the templates (1111)-(1113) may be identical or different. The sizes of the templates (1111)-(1113) may be identical or different.

FIG. 11A shows an example where the bottom side of the boundary (1141) may be extended. Other sides of the boundary (1141) may be extended (e.g., extrapolated) similarly. For a top side (e.g., a top boundary) of the boundary (1141), the top boundary may be flipped and considered as the bottom boundary, and the extrapolation method applied to the bottom boundary may be applied to the top boundary similarly. FIG. 11B shows an example where the top side (e.g., the top boundary) of the boundary (1141) may be extended. A third set of templates (1131)-(1133) may be used to extend the top boundary. In an example, the third set of templates (1131)-(1133) may be considered as corresponding to the first set of templates (1111)-(1113), respectively. For example, filter coefficients of a filter may be determined based on the templates (1131)-(1132), similarly as described above with the templates (1111)-(1112). The values of the samples in the template (1133) may be extrapolated using the reconstructed samples in the template (1132) with the filter determined based on the templates (1131)-(1132).

In an example, the extrapolation of the right side (e.g., the right boundary) of the boundary (1141) may be applied in a similar way. For example, referring to FIG. 11B, a set of templates (1161)-(1163) may be used to extend the top boundary, similarly as described above. For a left side (e.g., a left boundary) of the boundary (1141), the left boundary may be flipped and considered as the right boundary, and the extrapolation method applied to the right boundary may be applied to the left boundary similarly.

Referring to FIG. 11A, an area (1102) may surround the picture (1101). In an example, the extrapolation method may be used to extrapolate samples in the entire area (1102). An extended size in the vertical direction may be a dimension of the area (1102) along the vertical direction. An extended size in a horizontal direction may be a dimension of the area (1102) along the horizontal direction. For the area (1102), the extended size in the vertical direction may be identical to or different from the extended size in a horizontal direction

In an example, the extrapolation method may be used to extrapolate samples in a portion of the area (1102), and other method(s) may be used to extrapolate samples in other portion(s) of the area (1102). In an example, the area (1102) includes areas at four corners such as a top-left area (1151), a top-right area (1152), a bottom-left area (1153), and a bottom-right area (1154). Samples in the areas (1151)-(1154) at the four corners may be padded (e.g., using the repetitive padding method described in FIG. 9A) from the extrapolated samples. The extrapolated samples may be obtained using the extrapolation method described in FIGS. 11A-11B.

In an aspect, the extrapolation method may be performed by applying a formula (or the filter) to the samples in the second template (1112). In an example, the samples in the second template (1112) includes samples (e.g., reconstructed samples) along the boundary (1141), and the extrapolation method is performed by applying the filter to the samples along the boundary (1141).

In an example, the filter is described using Eq. (2).

$$pred = {\sum }_{i = 0}^{n} ( {α}_{i} \times p ( {x}_{i} , {y}_{i} ) ) + β \qquad Eq . ( 2 )$$

n may be a non-negative integer. p(xᵢ, yᵢ) represents an input sample to the filter. i may be from 0 to n. p(xᵢ, yᵢ) where i is from 0 to n may include a group of samples (e.g., a group of the reconstructed samples), and a number of the group of samples may be (n+1). In an example, p(xᵢ, yᵢ) may include a group of samples in the second template (1112). In an example, p(xᵢ, yᵢ) may include a group of samples along the boundary (1141) within a predefined filter shape. The filter coefficients of the filter described in Eq. (2) may include the parameters αᵢ (i is from 0 to n) and β. The parameters αᵢ (i is from 0 to n) and β may be derived as described in FIGS. 11A-11B, such as based on the available samples along the picture boundary (1141) from the templates (1111)-(1112). In an example, the available samples include the reconstructed samples in the first region (1110) including the templates (1111)-(1112)).

In an aspect, referring to FIG. 11C, a dimension of the second template (1112) along a side of the boundary (1141) may be a dimension of a coding block that is parallel to the side of the boundary (1141), and a dimension of the first template (1111) along the side of the boundary (1141) is greater than the dimension of the second template (1112) along the side of the boundary (1141).

In an example, the sizes of the templates (1111)-(1112) may be different. In an example, a size (or a dimension) of the second template (1112) along a side of the picture boundary (1141) is determined as a size of a coding block along the side of the picture boundary (1141). For example, referring to FIG. 11C, a width of the second template (1112) along the bottom side of the picture boundary (1141) is determined as a width of the coding block along the bottom side of the picture boundary (1141). In an example, referring to FIG. 11B, a height of the template (1162) along the right side of the picture boundary (1141) is determined as a height of a coding block along the right side of the picture boundary (1141). In an aspect, referring to FIG. 11C, the first template (1111) may have more samples than the second template (1112). In an example, a height of the second template (1112) may be identical to or different from a height of the coding block.

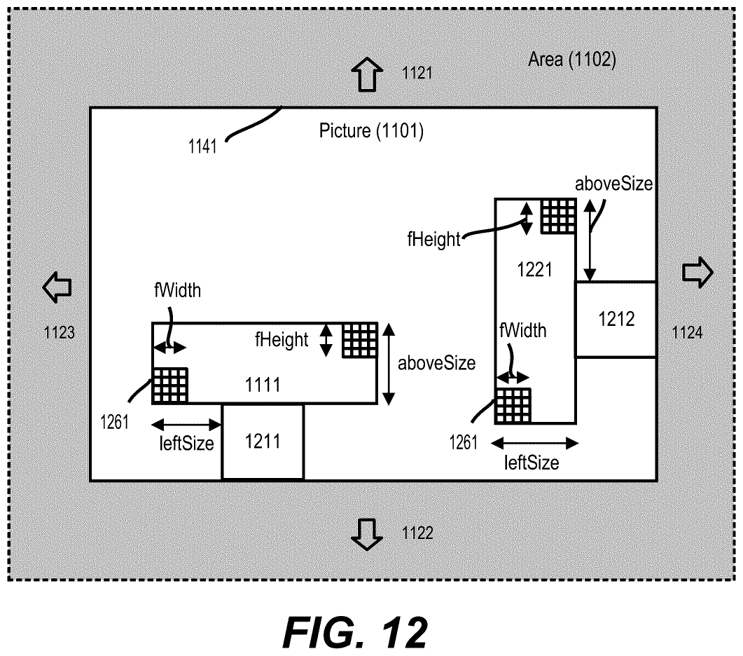

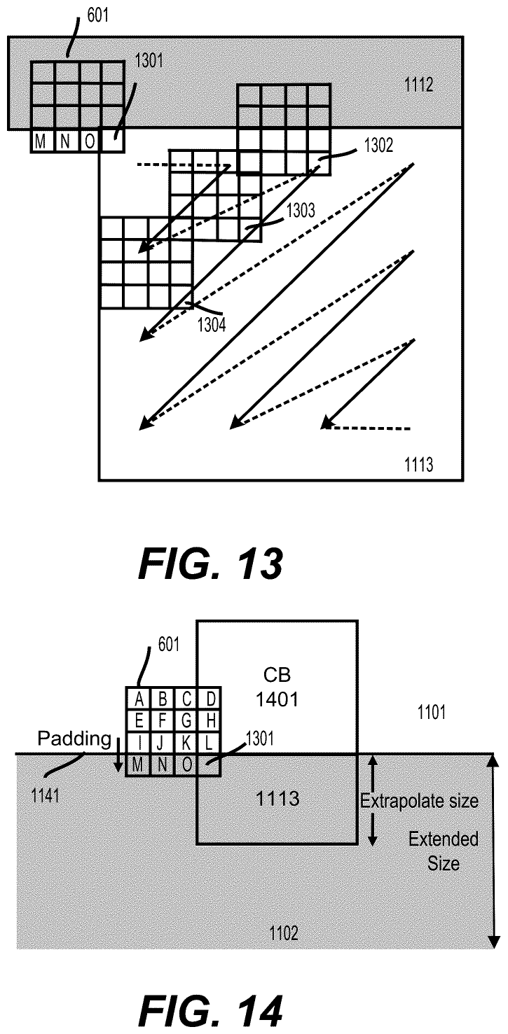

In an aspect, referring to FIG. 12, a dimension of the first template (1111) along a side of the boundary (1141) may include a sum of (i) a dimension of a coding block along the side of the boundary (1141) and (ii) a parameter. The parameter may depend on a minimum of a width W of the coding block and a height H of the coding block. In an example, the parameter may be 2×leftSize or 2×aboveSize. Parameters leftSize or aboveSize are described below.

In an example, the size of the first template (1111) is determined by the size of the coding block, the left size (e.g., indicated by the parameter leftSize), and/or the above size (e.g., indicated by the parameter aboveSize), as shown in FIG. 12. FIG. 12 shows an example where the size of the first template (1111) is based on the size of the coding block (1211) according to an aspect of the disclosure.

In an example, the coding block (1211) is positioned on the bottom side of the boundary (1141), and the first template (1111) is above the coding block (1211). The first template (1111) is referred to as a top template. A width of the top template (1111) may be equal to 2×leftSize+a width of the coding block (1211). In an example, the second template (1112) is determined based on the coding block (1211). For example, the second template (1112) includes the coding block (1211) and additional reconstructed samples in the picture (1101). Which additional reconstructed samples are included in the second template (1112) may depend on a size and a shape of the filter. Referring to FIG. 12, the filter (1261) has a filter width (fWidth) and a filter height (fHeight). When the filter shape (601) is used, the additional reconstructed samples may include 3 columns (e.g., fWidth−1) of reconstructed samples to the left of the coding block (1211).

In an example, a coding block (1212) is positioned on the right side of the boundary (1141), and a first template (1221) is to the left of the coding block (1212). The first template (1221) is referred to as a left template. A height of the left template (1221) may be equal to 2×aboveSize+a height of the coding block (1212). In an example, a second template corresponding to the first template (1221) is determined based on the coding block (1212), similarly as described above with respect to the coding block (1211).

In FIG. 12, the coding blocks (1211)-(1212) correspond to the second templates that are adjacent to the boundary (1141), and the reconstructed samples in the second templates may be used to extrapolate the samples in the area (1102).

In an example, the aboveSize and leftSize may be determined based on a minimum of a width W of a coding block and a height H of the coding block such as min (W, H).

Referring to FIG. 11A, in an aspect, a position of the first template (1111) relative to the second template (1112) depends on a position of the second template (1112) relative to the boundary (1141) of the current picture. For the second template (1112) along the bottom boundary, only a top template (e.g., (1111) is allowed. Referring to FIG. 11B, for the second template (1162) along the right boundary, only a left template (e.g., (1161) is allowed. In an example, referring to FIG. 12, the top template (1111) and the left template (1221) may be position dependent. For example, whether the top template (1111) or the left template (1221) is allowed depends on the position of the coding block (1211) or the coding block (1212). For example, for the coding block (1211) along the bottom boundary, only a top template (e.g., (1111) is allowed. For the coding block (1212) along the right boundary, only a left template (e.g., (1221) is allowed.

In an aspect, three filter shapes may include a first filter shape F0 with a number of input samples in a vertical direction that is equal to a number of the input samples in a horizontal direction, a second filter shape F1 with a number of input samples in the horizontal direction that is greater than a number of the input samples in the vertical direction, and a third filter shape F2 with a number of input samples in the vertical direction that is greater than a number of the input samples in the horizontal direction. Referring back to FIG. 6, an example of the first filter shape F0 is the filter shape (601), an example of the second filter shape F1 is the filter shape (602), and an example of the third filter shape F2 is the filter shape (603). In an example, a syntax element may indicate a filter shape of the filter as one of the three filter shapes. The filter shape of the filter may be determined based on the syntax element. In an example, the three extrapolation filters are defined such as shown in FIG. 6, and one of the pre-defined filters (e.g., (601)-(603)) is signaled to be used in the extrapolation method.

In an aspect, referring to FIG. 13, each sample in the third template (1113) may be extrapolated according to a scanning order by applying the filter to at least one of (i) the reconstructed samples in the second template (1112) and (ii) previously extrapolated samples in the third template (1113). The filter may be recursively applied to predict the values of the samples in the second template (1112) when the filter coefficients are calculated. In an aspect, the filter with the determined filter coefficients may be recursively applied to extrapolate the values of the samples in the third template (1113), for example, according to a scanning order (e.g., a pre-defined scanning order). The scanning order may be a diagonal scan order, a raster scan order, or the like.

FIG. 13 shows an example of predicting (e.g., extrapolating) samples recursively in the third template (1113) with the filter (e.g., filter shape (601)) in the diagonal scan order according to an aspect of the disclosure. Input samples used to predict the top-left sample (1301) in the third template (1113) may include reconstructed samples in the second template (1112). In the example shown in FIG. 13, if samples M-O in the bottom row of the filter (601) is not reconstructed, the samples M-O may be padded using other neighboring reconstructed samples, such as the reconstructed samples in the second template (1112), as described below in FIG. 14.

For some samples within the third template (1113), respective input samples may include previously predicted samples (e.g., previously extrapolated samples) in the third template (1113). In an example, the input samples to predict the sample (1302) in the third template (1113) includes reconstructed samples in the second template (1112) and previously extrapolated samples in the third template (1113). In an example, the respective input samples to predict the samples (1303)-(1304) in the third template (1113) includes only previously extrapolated samples in the third template (1113).

In an example, an area of the second template (1112) is less than or equal to a pre-defined block size M×N, and M and N are positive numbers. For example, the extrapolation filter described in the disclosure may be restricted to a block size of a coding block being smaller than or equal to the pre-defined block size M×N, such as 32×32.

In an example, the filter described in the disclosure may be used to extrapolate the samples that are out of the picture boundary (1141), such as the samples in the area (1102) as shown in FIG. 14. In an example, because of the filter shape, some of the input samples may not be available, the unavailable samples may be padded by the closest samples on the picture boundary (1141), such as shown in FIG. 14. FIG. 14 shows an example of padding samples for the filter input when extrapolating samples that are out of the picture boundary (1141) according to an aspect of the disclosure. In this case, the filter having the filter shape (601) is applied to extrapolate the values of the samples in the third template (1113). The third template (1113) may be located below a boundary coding block (1401) which may correspond to the second template (1112), for example. In an example, the second template (1112) includes the coding block (1401) and three columns (e.g., including samples A to C, E to G, and I to K) of reconstructed samples to the left of the CB (1401).

For example, the filter (601) is applied to extrapolate the top-left sample (1301) in the third template (1113). The input samples used to extrapolate the top-left sample (1301) include top three rows (e.g., samples A-L) in the filter (601) that are already reconstructed and a bottom row including the samples M-O in the filter (601) that are not available (e.g., not reconstructed). In an example, the samples M-O in the filter (601) may be padded using the reconstructed samples I-K, respectively.

In an example, referring to FIG. 14, a height of the third template (1113) is referred to as an extrapolated size (e.g., an extrapolated size along a vertical direction). The extrapolated size may be a pre-defined number. The extrapolated size may be less than an extended size for inter prediction in the vertical direction, as shown in FIG. 14. When the extrapolated size of the third template (1113) is less than the extended size of the area (1102) in the vertical direction, multiple extensions may be performed. A first extension may include extrapolating the values of the samples in the third template (1113), and subsequently a second extension may include padding an area that is below the third template (1113) using the extrapolated samples in the third template (1113). Similarly, the multiple extensions may be performed when an extrapolated size of the third template (1113) is less than the extended size of the area (1102) in the horizontal direction.

In an aspect, whether to extrapolate the values of the samples in the third template (1113) may be determined based on whether the second template (1112) is reconstructed using intra prediction. When the second template (1112) is reconstructed using intra prediction, the extrapolation of the values of the samples in the third template (1113) may be performed.

The extrapolation method may be applied to extend a boundary in an I picture. For example, the picture (1101) may be an I picture.

In some examples, the extrapolation method may be applied to extend a boundary in an P picture or a B picture. In this case, the extrapolation method may only apply for region(s) of a boundary where coding block(s) in the region(s) are predicted with intra prediction (e.g., using extrapolation-based intra prediction, such as the EIP mode). In an example, a picture is a P picture or a B picture, and a boundary of the picture may include first regions that are intra predicted and second regions that are inter predicted. The extrapolation method applies to the first regions to extend the boundary at the first regions, and the MC padding method (e.g., such as shown in FIG. 9B) may be applied to the second regions to extend the boundary at the second regions.

In an aspect, the extrapolation method may be performed with the intra prediction mode, such as a conventional intra mode. Examples of intra prediction modes include but are not limited to angular prediction modes, the planar mode, the DC mode, and the like such as described in FIGS. 4A, 4B, and 4C.

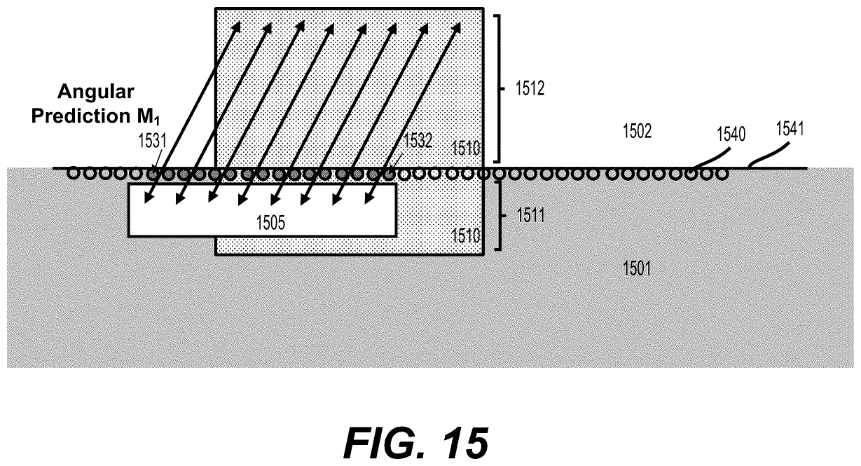

FIG. 15 shows an example of the extrapolation method performed with an angular intra prediction mode according to an aspect of the disclosure. A picture (1501) has a boundary (or a frame border) (1541). Boundary samples (or border pixels) (1540) on the boundary (1541) are indicted by circles. The picture (1501) includes the boundary samples (1540). An area (1502) is located outside the picture (1501). In an example, a block in another picture is being inter coded, for example being reconstructed. An MV of the block in the other picture points to a reference block (1510). The reference block (1510) is partially located inside the picture (1501), and partially located outside the picture (1501). The picture (1501) may be referred to as a reference picture (or a reference frame) of the block in the other picture.

In an example, the reference block (1510) includes a first area (1511) that is inside the picture (1501), and a second area (1512) that is outside the picture (1501). Thus, samples in the first area (1511) are already reconstructed and may be used to predict the block in the other picture, and samples in the second area (1512) are not reconstructed and may not be available to predict the block in the other picture. Thus, the boundary (1541) of the picture (1501) is to be extended.

The extrapolation method may be performed to extrapolate values of the samples in the second area (1512). An intra prediction mode, such as an angular prediction mode, may be used in the extrapolation method.

Referring to FIG. 15, the intra prediction mode, such as the angular prediction mode, may be obtained from coding block(s) (e.g., boundary coding block(s)) along the picture boundary (1541). The intra prediction mode of the coding block(s) along the picture boundary (1541) may be reused to extend the picture boundary (1541). In an example, intra prediction information (e.g., the angular prediction mode) may be determined from the coding block(s) within an area (e.g., referred to as a template area) (1505). The values of the samples in the second area (1512) may be obtained from a subset (e.g., the boundary samples from (1531) to (1532)) of the boundary samples (1540) using the determined angular prediction mode such as the angular prediction mode M1 in FIG. 15. In an example, which of the boundary samples (1540) are used in the extrapolation method may be determined based on the angular prediction mode M1 and the location of the second area (1512).

In an example, the area (1505) also includes the subset (e.g., the boundary samples from (1531) to (1532)) of the boundary samples (1540).

In an example, the area (1505) has a pre-defined size. In an example, the area (1505) may not be aligned with the extrapolated samples in the second area (1512), for example, when the angular intra prediction mode M1 is applied. Referring to FIG. 15, the second area (1512) is shifted along the horizontal direction with respect to the area (1505), and the second area (1512) and the area (1505) are misaligned, for example, when a direction of the angular intra prediction mode M1 is not perpendicular.

In an example, an angle of the misalignment may be indicated by the angular intra prediction mode M1. When the angular intra prediction mode M1 is a vertical mode (e.g., a mode 50 in FIG. 4A), the second area (1512) and the area (1505) are aligned. The extrapolation method performed with the vertical mode may be equivalent to the repetitive padding described in FIG. 9A, for example, when the second area (1512) and the area (1505) are aligned.

In an example, referring to FIG. 15, when the boundary samples (1540) (e.g., a line of reconstructed samples) are a row of reconstructed samples, the second area (1512) is shifted horizontally with respect to the row of reconstructed samples and the area (1505). When the line of reconstructed samples is a column of reconstructed samples, an area that is extrapolated may be shifted vertically with respect to the column of reconstructed samples and an area used in the extrapolation.

Referring to FIGS. 11A and 15, the extrapolation method may be performed using the filter (e.g., FIG. 11A) and/or using the intra prediction mode (e.g., FIG. 15). The first region (1110) in FIG. 11A may be used to determine the filter (e.g., the filter coefficients). The area (1505) in FIG. 15 may be used to determine the intra prediction mode, and thus the area (1505) in FIG. 15 may also be referred to as the first region (1505). The third template (1113) in FIG. 11A is outside the boundary (1141) and the filter is used to extrapolate the values of the samples in the third template (1113). Similarly, the second area (1512) in FIG. 15 is outside the boundary (1541) and the intra prediction mode is used to extrapolate the values of the samples in the second area (1512), and thus the second area (1512) may be referred to as the third template (1512). The first region (1110) in FIG. 11A may include the first template (1111) and the second template (1112) where the second template (1112) is used in the extrapolation. Similarly, the area (1505) may include a first template including non-boundary samples and a second template including the subset of the boundary samples (1540) used in the extrapolation. Thus, referring to FIG. 15, the intra prediction mode used to extrapolate may be determined as the intra prediction mode used to obtain the reconstructed samples in the first region (1505). The values of the samples in the third template (1512) may be extrapolated from the reconstructed samples in the second template (e.g., including the subset of the boundary samples (1540)) using the intra prediction mode.

In an aspect, the extrapolation method with the filter or with the intra prediction mode may be applied to intra frames or I frames only.

In an aspect, the extrapolation method with the filter or with the intra prediction mode may be applied to a partial inter picture such as a P frame or a B frame to extend a boundary of a P frame or a B frame where coding block(s) (e.g., boundary coding block(s)) on the boundary of the partial inter picture are intra coded. In an example, in a P frame or a B frame, samples in the boundary coding block(s) that are intra coded may be used to extrapolate samples in areas that are outside the boundary, and samples in boundary coding block(s) that are inter coded may be used to generate samples that are outside the boundary using the MC padding.

Various methods used to extend a boundary of a picture may be combined. In an example, the picture is an I picture, and the extrapolation method based on a filter and/or an intra prediction mode may be used to extend the boundary. In some examples, repetitive padding may be used to further extend the boundary based on the extrapolated samples, similarly as described in FIG. 9B. In an example, the picture is a P picture or a B picture, and the extrapolation method based on a filter and/or an intra prediction mode may be used together with the MC padding to extend the boundary. In some examples, repetitive padding may be used to further extend the boundary based on the extrapolated samples obtained by the extrapolation methods and/or the MC padding, similarly as described in FIG. 9B.

In an aspect, referring to FIG. 11A or 12, when the second template (1112) or the coding block (1211) is predicted using extrapolation-based intra prediction, the values of the samples in the third template (1113) may be extrapolated using the filter. In an aspect, referring to FIG. 15, when the area (1505) is predicted using the intra prediction mode, the values of the samples in the third template (1512) may be extrapolated using the intra prediction mode. In an example, the area (1505) includes one or more coding blocks that are predicted using the intra prediction mode.

In an aspect, the extrapolation method depends on the intra coding block on the boundary. In an example, when an intra coding block is extrapolated, then the extrapolation method using a filter is used, such as described in FIGS. 11A-11C and 12-14. In another example, when an intra coding block is predicted with an intra prediction mode (e.g., an angular prediction mode, the planar mode, the DC mode, or the like), then the extrapolation method using the intra prediction mode is used, such as described in FIG. 15. In an aspect, the extrapolation method that depends on the intra coding block on the boundary may result in some area that is not filled completely, since extended samples using the intra prediction mode may not be vertically or horizontally extended. In this case, the unfilled area may be padded by the closest extrapolated samples.

In an aspect, since an extended sample obtained from the extrapolation method based on an intra prediction mode may not be extended vertically or horizontally, a same sample may be predicted using both the extrapolation method based on a filter and the extrapolation method based on an intra prediction mode. Thus, the extrapolation method based on a filter and the extrapolation method based on an intra prediction mode may result in overlapping samples. In this case, a weighted sample may be derived based on prediction samples extended from both the extrapolation method based on a filter and the extrapolation method based on an intra prediction mode. For example, a value for a sample in the third template may be determined using the filter and the intra prediction mode, an extrapolated value of the sample may be determined based on a weighted average of (i) the value of the sample determined using the filter and (ii) the value of the sample determined using the intra prediction mode

FIG. 16 shows a flow chart outlining a process (1600) according to an aspect of the disclosure. The process (1600) can be used in an apparatus, such as a video decoder. In various aspects, the process (1600) is executed by processing circuitry, such as the processing circuitry that performs functions of the video decoder (110), the processing circuitry that performs functions of the video decoder (210), and the like. In some aspects, the process (1600) is implemented in software instructions, thus when the processing circuitry executes the software instructions, the processing circuitry performs the process (1600). The process starts at (S1601) and proceeds to (S1610).

At (S1610), one of a filter and an intra prediction mode is determined based on reconstructed samples in a first region that is within a current picture. The first region includes a first template and a second template. The second template includes reconstructed samples on a boundary of the current picture and is located between the first region and the boundary of the current picture.

In an example, a dimension of the second template along a side of the boundary is a dimension of a coding block along the side of the boundary, and a dimension of the first template along the boundary is greater than the dimension of the second template along the side of the boundary.

In an example, a dimension of the first template along a side of the boundary includes a sum of (i) a dimension of a coding block along the side of the boundary and (ii) a parameter that depends on a minimum of a width of the coding block and a height of the coding block.

In an example, a position of the first template relative to the second template depends on a position of the second template relative to the boundary of the current picture.

In an example, three filter shapes include a first filter shape F0 with a number of input samples in a vertical direction that is equal to a number of the input samples in a horizontal direction, a second filter shape F1 with a number of input samples in the horizontal direction that is greater than a number of the input samples in the vertical direction, and a third filter shape F2 with a number of input samples in the vertical direction that is greater than a number of the input samples in the horizontal direction. Coded information including a syntax element indicating a filter shape of the filter as one of the three filter shapes may be received, and the filter shape of the filter may be determined based on the syntax element.

At (S1610), values of samples in a third template that is outside the boundary of the current picture are extrapolated, using the one of the filter and the intra prediction mode, from values of reconstructed samples in the second template.

Then, the process proceeds to (S1699) and terminates.

The process (1600) can be suitably adapted. Step(s) in the process (1600) can be modified and/or omitted. Additional step(s) can be added. Any suitable order of implementation can be used.

In an aspect, the one of the filter and the intra prediction mode is the filter. Filter coefficients of the filter are determined based on (i) predicted samples obtained by applying the filter to the first template and (i) the reconstructed samples in the second template. The values of the samples in the third template are extrapolated by applying the filter with the determined filter coefficients to one of (i) the reconstructed samples in the second template and (ii) previously extrapolated samples in the third template.

In an example, whether to extrapolate the values of the samples in the third template is determined based on whether the second template is reconstructed using intra prediction. When the second template is reconstructed using intra prediction, the extrapolation of the values of the samples in the third template is performed.

In an example, the one of the filter and the intra prediction mode is the intra prediction mode. The intra prediction mode used to extrapolate is determined as the intra prediction mode used to obtain the reconstructed samples in the first region. The values of the samples in the third template may be extrapolated from the reconstructed samples in the second template using the intra prediction mode.

In an example, the values of the samples in the third template are extrapolated using the filter when the second template is predicted using extrapolation-based intra prediction. In an example, the values of the samples in the third template are extrapolated using the intra prediction mode when the second template is predicted using the intra prediction mode.

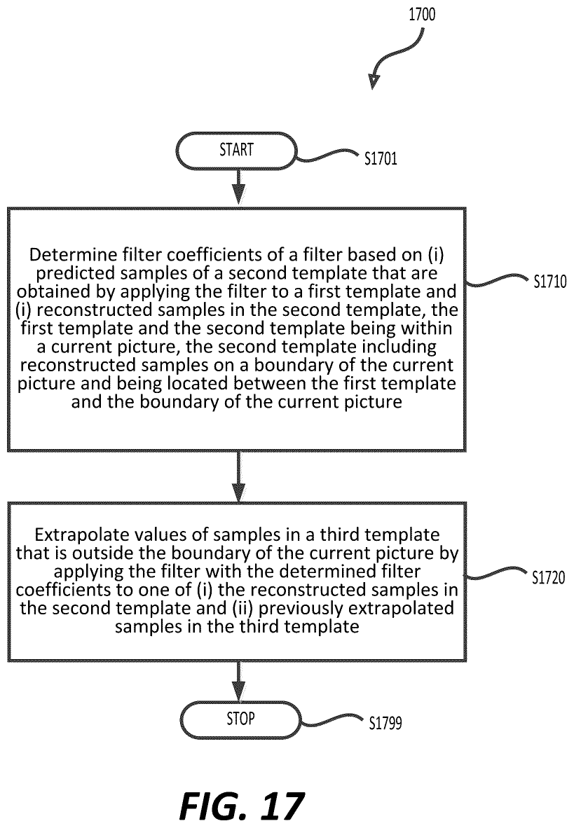

FIG. 17 shows a flow chart outlining a process (1700) according to an aspect of the disclosure. The process (1700) can be used in a video encoder. In various aspects, the process (1700) is executed by processing circuitry, such as the processing circuitry that performs functions of the video encoder (103), the processing circuitry that performs functions of the video encoder (303), and the like. In some aspects, the process (1700) is implemented in software instructions, thus when the processing circuitry executes the software instructions, the processing circuitry performs the process (1700). The process starts at (S1701) and proceeds to (S1710).

At (S1710), filter coefficients of a filter are determined based on (i) predicted samples of a second template that are obtained by applying the filter to a first template and (i) reconstructed samples in the second template. The first template and the second template are within a current picture. The second template includes reconstructed samples on a boundary of the current picture and is located between the first template and the boundary of the current picture.

In an example, a dimension of the second template along a side of the boundary is a dimension of a coding block along the side of the boundary, and a dimension of the first template along the boundary is greater than the dimension of the second template along the side of the boundary.

In an example, a dimension of the first template along a side of the boundary includes a sum of (i) a dimension of a coding block along the side of the boundary and (ii) a parameter that depends on a minimum of a width of the coding block and a height of the coding block.

In an example, the second template is predicted using extrapolation-based intra prediction.

At (S1720), values of samples in a third template that is outside the boundary of the current picture are extrapolated by applying the filter with the determined filter coefficients to one of (i) the reconstructed samples in the second template and (ii) previously extrapolated samples in the third template.

Then, the process proceeds to (S1799) and terminates.

The process (1700) can be suitably adapted. Step(s) in the process (1700) can be modified and/or omitted. Additional step(s) can be added. Any suitable order of implementation can be used.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

The bitstream includes a syntax element indicating that a second template that is at a boundary of a current picture is intra predicted, and the second template is within the current picture. The format rule specifies that filter coefficients of a filter are determined based on (i) predicted samples of the second template that are obtained by applying the filter to a first template and (i) reconstructed samples in the second template. The first template and the second template are within a current picture, and the second template includes reconstructed samples on the boundary of the current picture and is located between the first template and the boundary of the current picture. The format rule specifies that values of samples in a third template that is outside the boundary of the current picture are extrapolated by applying the filter with the determined filter coefficients to one of (i) the reconstructed samples in the second template and (ii) previously extrapolated samples in the third template.

In an example, the format rule specifies that a dimension of the second template along a side of the boundary is a dimension of a coding block along the side of the boundary, and a dimension of the first template along the boundary is greater than the dimension of the second template along the side of the boundary.

Aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

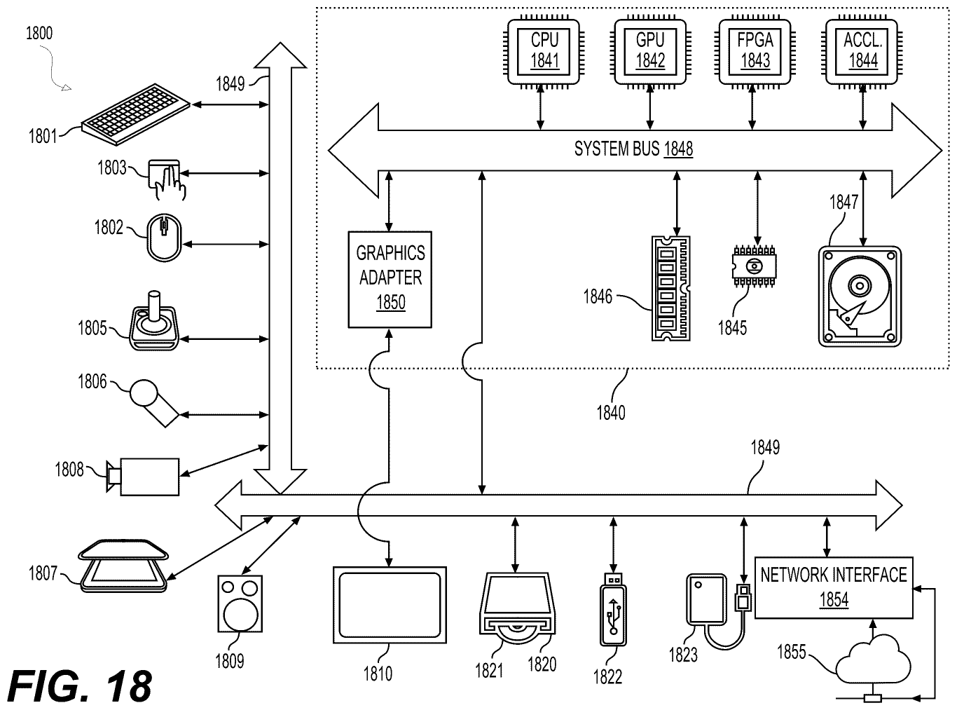

The techniques described above, can be implemented as computer software using computer-readable instructions and physically stored in one or more computer-readable media. For example, FIG. 18 shows a computer system (1800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 18 for computer system (1800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1800).

Computer system (1800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1801), mouse (1802), trackpad (1803), touch screen (1810), data-glove (not shown), joystick (1805), microphone (1806), scanner (1807), camera (1808).

Computer system (1800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1810), data-glove (not shown), or joystick (1805), but there can also be tactile feedback devices that do not serve as input devices), audio output devices (such as: speakers (1809), headphones (not depicted)), visual output devices (such as screens (1810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1800) can also include human accessible storage devices and their associated media such as optical media including CD/DVD ROM/RW (1820) with CD/DVD or the like media (1821), thumb-drive (1822), removable hard drive or solid state drive (1823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1800) can also include an interface (1854) to one or more communication networks (1855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1849) (such as, for example USB ports of the computer system (1800)); others are commonly integrated into the core of the computer system (1800) by attachment to a system bus as described below (for example Ethernet interface into a PC computer system or cellular network interface into a smartphone computer system). Using any of these networks, computer system (1800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1840) of the computer system (1800).

The core (1840) can include one or more Central Processing Units (CPU) (1841), Graphics Processing Units (GPU) (1842), specialized programmable processing units in the form of Field Programmable Gate Areas (FPGA) (1843), hardware accelerators for certain tasks (1844), graphics adapters (1850), and so forth. These devices, along with Read-only memory (ROM) (1845), Random-access memory (1846), internal mass storage such as internal non-user accessible hard drives, SSDs, and the like (1847), may be connected through a system bus (1848). In some computer systems, the system bus (1848) can be accessible in the form of one or more physical plugs to enable extensions by additional CPUs, GPU, and the like. The peripheral devices can be attached either directly to the core's system bus (1848), or through a peripheral bus (1849). In an example, the screen (1810) can be connected to the graphics adapter (1850). Architectures for a peripheral bus include PCI, USB, and the like.

CPUs (1841), GPUs (1842), FPGAs (1843), and accelerators (1844) can execute certain instructions that, in combination, can make up the aforementioned computer code. That computer code can be stored in ROM (1845) or RAM (1846). Transitional data can also be stored in RAM (1846), whereas permanent data can be stored for example, in the internal mass storage (1847). Fast storage and retrieve to any of the memory devices can be enabled through the use of cache memory, that can be closely associated with one or more CPU (1841), GPU (1842), mass storage (1847), ROM (1845), RAM (1846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1800), and specifically the core (1840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1840) that are of non-transitory nature, such as core-internal mass storage (1847) or ROM (1845). The software implementing various aspects of the present disclosure can be stored in such devices and executed by core (1840). A computer-readable medium can include one or more memory devices or chips, according to particular needs. The software can cause the core (1840) and specifically the processors therein (including CPU, GPU, FPGA, and the like) to execute particular processes or particular parts of particular processes described herein, including defining data structures stored in RAM (1846) and modifying such data structures according to the processes defined by the software. In addition or as an alternative, the computer system can provide functionality as a result of logic hardwired or otherwise embodied in a circuit (for example: accelerator (1844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. An apparatus for video decoding, comprising:
processing circuitry configured to:
determine one of a filter and an intra prediction mode based on reconstructed samples in a first region that are within a current picture, the first region including a first template and a second template, the second template including reconstructed samples on a boundary of the current picture and being located between the first template and the boundary of the current picture; and
extrapolate, using the one of the filter and the intra prediction mode, values of samples in a third template that is outside the boundary of the current picture based on values of the reconstructed samples in the second template.

2. The apparatus of claim 1, wherein
the one of the filter and the intra prediction mode is the filter; and
the processing circuitry is configured to:
determine filter coefficients of the filter based on (i) predicted samples obtained by applying the filter to the first template and (i) the reconstructed samples in the second template; and
extrapolate the values of the samples in the third template by applying the filter with the determined filter coefficients to one of (i) the reconstructed samples in the second template and (ii) previously extrapolated samples in the third template.

3. The apparatus of claim 2, wherein a dimension of the second template along a side of the boundary is a dimension of a coding block along the side of the boundary, and a dimension of the first template along the boundary is greater than the dimension of the second template along the side of the boundary.

4. The apparatus of claim 2, wherein
a dimension of the first template along a side of the boundary includes a sum of (i) a dimension of a coding block along the side of the boundary and (ii) a parameter that depends on a minimum of a width of the coding block and a height of the coding block.

5. The apparatus of claim 2, wherein a position of the first template relative to the second template depends on a position of the second template relative to the boundary of the current picture.

6. The apparatus of claim 1, wherein
three filter shapes include a first filter shape F0 with a number of input samples in a vertical direction that is equal to a number of the input samples in a horizontal direction, a second filter shape F1 with a number of input samples in the horizontal direction that is greater than a number of the input samples in the vertical direction, and a third filter shape F2 with a number of input samples in the vertical direction that is greater than a number of the input samples in the horizontal direction; and
the processing circuitry is further configured to:
receive coded information including a syntax element indicating a filter shape of the filter as one of the three filter shapes; and
determine the filter shape of the filter based on the syntax element.

7. The apparatus of claim 2, wherein the processing circuitry is configured to:
determine whether to extrapolate the values of the samples in the third template based on whether the second template is reconstructed using intra prediction; and
when the second template is reconstructed using intra prediction, perform the extrapolation of the values of the samples in the third template.

8. The apparatus of claim 1, wherein
the one of the filter and the intra prediction mode is the intra prediction mode; and
the processing circuitry is configured to:
determine the intra prediction mode used to extrapolate as the intra prediction mode used to obtain the reconstructed samples in the first region; and
extrapolate the values of the samples in the third template from the reconstructed samples in the second template using the intra prediction mode.

9. A method for video encoding, comprising:
determining one of a filter and an intra prediction mode based on reconstructed samples in a first region that are within a current picture, the first region including a first template and a second template, the second template including reconstructed samples on a boundary of the current picture and being located between the first template and the boundary of the current picture; and
extrapolating, using the one of the filter and the intra prediction mode, values of samples in a third template that are outside the boundary of the current picture based on values of the reconstructed samples in the second template.

10. The method of claim 9, wherein
the one of the filter and the intra prediction mode is the filter; and
the determining the one of the filter and the intra prediction mode includes determining filter coefficients of the filter based on (i) predicted samples obtained by applying the filter to the first template and (ii) the reconstructed samples in the second template; and
the extrapolating the values includes extrapolating the values of the samples in the third template by applying the filter with the determined filter coefficients to one of (i) the reconstructed samples in the second template and (ii) previously extrapolated samples in the third template.

11. The method of claim 10, wherein a dimension of the second template along a side of the boundary is a dimension of a coding block along the side of the boundary, and a dimension of the first template along the boundary is greater than the dimension of the second template along the side of the boundary.

12. The method of claim 10, wherein
a dimension of the first template along a side of the boundary includes a sum of (i) a dimension of a coding block along the side of the boundary and (ii) a parameter that depends on a minimum of a width of the coding block and a height of the coding block.

13. The method of claim 10, wherein a position of the first template relative to the second template depends on a position of the second template relative to the boundary of the current picture.

14. The method of claim 9, wherein
three filter shapes include a first filter shape F0 with a number of input samples in a vertical direction that is equal to a number of the input samples in a horizontal direction, a second filter shape F1 with a number of input samples in the horizontal direction that is greater than a number of the input samples in the vertical direction, and a third filter shape F2 with a number of input samples in the vertical direction that is greater than a number of the input samples in the horizontal direction; and
the method includes:
determining a filter shape of the filter as one of the three filter shapes;
encoding a syntax element indicating the filter shape of the filter.

15. The method of claim 10, further comprising:
determining whether to extrapolate the values of the samples in the third template based on whether the second template is reconstructed using intra prediction; and
when the second template is reconstructed using intra prediction, performing the extrapolation of the values of the samples in the third template.

16. The method of claim 9, wherein
the one of the filter and the intra prediction mode is the intra prediction mode; and
the determining the one of the filter and the intra prediction mode includes determining the intra prediction mode used to extrapolate as the intra prediction mode used to obtain the reconstructed samples in the first region; and
the extrapolating the values includes extrapolating the values of the samples in the third template from the reconstructed samples in the second template using the intra prediction mode.

17. A non-transitory computer-readable storage medium storing instructions which when executed by a processor cause the processor to perform an encoding method comprising:
determining one of a filter and an intra prediction mode based on reconstructed samples in a first region that are within a current picture, the first region including a first template and a second template, the second template including reconstructed samples on a boundary of the current picture and being located between the first template and the boundary of the current picture;
extrapolating, using the one of the filter and the intra prediction mode, values of samples in a third template that are outside the boundary of the current picture based on values of the reconstructed samples in the second template; and
transmitting a bitstream including the current picture.

18. The non-transitory computer-readable storage medium of claim 17, wherein
the one of the filter and the intra prediction mode is the filter; and
filter coefficients of the filter are determined based on (i) predicted samples obtained by applying the filter to the first template and (ii) the reconstructed samples in the second template; and
the values of the samples in the third template are extrapolated by applying the filter with the determined filter coefficients to one of (i) the reconstructed samples in the second template and (ii) previously extrapolated samples in the third template.

19. The non-transitory computer-readable storage medium of claim 18, wherein a dimension of the second template along a side of the boundary is a dimension of a coding block along the side of the boundary, and a dimension of the first template along the boundary is greater than the dimension of the second template along the side of the boundary.

20. The non-transitory computer-readable storage medium of claim 18, wherein a dimension of the first template along a side of the boundary includes a sum of (i) a dimension of a coding block along the side of the boundary and (ii) a parameter that depends on a minimum of a width of the coding block and a height of the coding block.
